(19) United States
(12) Patent Application Publication
(10) Pub. No.: US 2015/0047585 A1
(43) Pub. Date: Feb. 19, 2015

(54) BEARING ASSEMBLY IN AN ENGINE HOUSING OF AN INTERNAL COMBUSTION ENGINE AND METHOD FOR ITS MANUFACTURE

(71) Applicant: Volker Wendt, Uchtelhausen/Zell (DE)

(72) Inventor: Volker Wendt, Uchtelhausen/Zell (DE)

(73) Assignee: AKTIEBOLAGET SKF, Goteborg (SE)

(21) Appl. No.: 14/458,841

(22) Filed: Aug. 13, 2014

(30) Foreign Application Priority Data
Aug. 14, 2013 (DE) 102013216138.7

(51) Int. Cl. F02F 7/00; F16C 43/04; F01L 1/047

(52) U.S. Cl. CPC F02F 7/006; F01L 1/047; F02F 7/0082; F02F 7/0095; F16C 43/04; F01L 2001/0476
USPC 123/90.6; 123/195 C; 29/888.01

(57) ABSTRACT

An engine housing of an internal combustion engine has at least one bore and a bearing assembly mounted in the bore for rotatably supporting a camshaft via first and second rolling-element bearings that each have an outer ring. A slot-shaped gap extends from the bore through at least a part of the engine housing up to a point at the surface of the engine housing, at least one screw bore is disposed in a first portion of the engine housing on a first side of the slot-shaped gap, a threaded bore is disposed in a second portion of the engine housing on a second side of the slot-shaped gap, and a screw extends through the screw bore, across the slot-shaped gap and into the threaded bore and is configured to pull together the first portion and the second portion to clamp the outer ring.

### CROSS-REFERENCE

This application claims priority to German patent application no. 10 2013 216 138.7 filed on Aug. 14, 2014, the contents of which are fully incorporated herein by reference.

### TECHNOLOGICAL FIELD

The present disclosure is directed to an engine housing of an internal combustion engine having a bearing assembly for rotatably supporting a camshaft, and, more specifically, to an engine housing of an internal combustion engine having a roller element bearing assembly for rotatably supporting a camshaft at at least two points axially spaced from one another. A method for manufacturing an engine housing of an internal combustion engine having such a bearing assembly is also disclosed.

### BACKGROUND

Bearing assemblies are conventionally used to support camshafts in engine housings. Typically, the camshafts are supported by slide bearings. Engine housings may thus be provided with suitable bores into which shaft-like sections of the camshaft can be introduced. A clearance fit must be present between the shaft-like section and the bore in order to ensure the functionality of the sliding bearing. This clearance between the shaft-like section and the bore makes the installation of the camshaft into the engine housing relatively easy.

Rolling-element bearings are also of interest for supporting a camshaft in an engine housing. Rolling-element bearings may allow for the use of a smaller oil pump in the internal combustion engine and may help reduce friction. However, the use of rolling-element bearings in such an environment poses certain difficulties.

To install a camshaft and roller-element bearing assembly, it is necessary to axially insert the bearings, including their outer rings, in receiving bores in the engine housing. This can only be achieved with reasonable effort if there is a sliding fit between the receiving bore and the outer ring of the rolling-element bearing. In operation, however, it is desirable or necessary to have a tight fit of the outer ring in the receiving bore in the engine housing. If a tight fit is not provided, ring migration and thus material abrasion/removal can occur between the ring and the bore. This can even lead to ring breakage.

Accordingly, compromises are made in the design of engine housings and rolling-element bearings, and an optimal solution has heretofore not been possible.

### SUMMARY

The object of the disclosure is to provide an engine housing and a bearing assembly for rotatably supporting a camshaft in the engine housing using rolling-element bearings that addresses the foregoing difficulties. Thus, the disclosed bearing assembly allows for the simple installation of camshaft-supporting rolling-element bearings in the engine housing, while at the same time helping to ensure that the bearing outer rings of the rolling-element bearing are fixed in the bore and cannot rotate relative to the engine housing during operation of the internal combustion engine.

To achieve this object, a slot-shaped gap is provided in the engine housing that extends from a circumferential point of the at least one bore through at least one part of the engine housing up to a point on a surface of the engine housing. At least one screw bore is disposed in the part of the engine housing, which screw bore passes through the slot-shaped gap. A threaded bore is disposed in a section of the engine housing which is separated from the screw bore by the slot-shaped gap, and a screw extends through the screw bore and across the slot-shaped gap into the threaded bore to pull together and/or clamp two sections of the engine housing together using the screw. This in turn clamps the outer ring of the rolling-element bearing in the bore.

The slot-shaped gap preferably extends radially relative to the bore. The screw bore preferably passes through the slot-shaped gap such that the axis of the screw bore is perpendicular to the opposing boundary surfaces of the slot-shaped gap. A screw in a corresponding screw bore can be associated with each rolling-element bearing for supporting the camshaft.

The outer radius of the outer ring of the rolling-element bearing is preferably larger than the largest radial dimension of a cam of the camshaft. The screw can abut via its screw head on an outer side of the engine housing, and needle bearings are preferably used as rolling-element bearings.

A method for manufacturing an engine housing and bearing assembly is also provided. According to this method, a camshaft is rotatably supported in the engine housing using a bearing assembly and is supported at at least two points axially spaced from one another by a rolling-element bearing at each of the at least two points. The outer rings of the rolling-element bearings are disposed in at least one bore in the engine housing. The method includes a) providing a bore in the engine housing, the bore being configured to receive the rolling-element bearing supporting the camshaft, b) changing and/or adapting the bore relative to the outer diameter of the rolling-element bearing to a size that allows for a sliding fit between the outer ring of the rolling-element bearing and the bore, c) providing a screw bore in a part of the engine housing which lies between a circumferential point of the bore and a point on the surface of the engine housing such that the axis of the screw bore and the axis of the bore are skewed with respect to each other, d) providing a threaded bore in a section of the screw bore, e) providing a slot-shaped gap in the engine housing extending from the circumferential point of the bore through at least one part of the engine housing up to the point at a surface of the engine housing, f) installing the rolling-element bearing supporting the camshaft such that the outer ring of the rolling-element bearing is located in the bore, and g) installing a screw in the screw bore and tightening the screw to clamp the outer ring of the rolling-element bearing.

It is preferably that the slot-shaped gap is formed using a disk milling cutter. However, the bore can be provided in the engine housing as part of an original casting or manufacture of the engine housing or by a post-processing after the engine housing has been conventionally formed.

Another aspect of the disclosure comprises an engine housing of an internal combustion engine having a bore, a rolling element bearing assembly having an outer ring mounted in the bore, a camshaft rotatably supported by the bearing assembly, a slot-shaped gap extending from the bore to a surface of the engine housing, the slot-shaped gap having first and second opposing side walls, and a threaded fastener extending across the slot-shaped gap and configured to draw the first side wall toward the second side wall to clamp the outer ring in the bore.

A further aspect of the disclosure comprises a method for mounting a bearing assembly in at least one bore of an engine housing of an internal combustion engine, the bearing assembly being configured to rotatably support a camshaft at at least two points axially spaced from one another using at least one rolling-element bearing having an outer ring disposed in the at least one bore. The method includes providing an engine housing having a first bore configured to receive the camshaft and the bearing assembly, and enlarging the first bore to a size greater than an outer diameter of the at least one rolling-element bearing to enable a sliding fit between the outer ring of the at least one rolling-element bearing and the first bore. The method also includes forming a second bore in a part of the engine housing which lies outside the first bore between a circumferential point of the first bore and a point of a surface of the engine housing such that an axis of the second bore is offset from and not parallel to an axis of rotation of the camshaft, the second bore having a threaded portion. The method also includes forming a slot-like gap in the engine housing from the circumferential point of the first bore through at least one part of the engine housing up to the point of the surface of the engine housing, installing the rolling-element bearing assembly supporting the camshaft such that the outer ring of the at least one rolling-element bearing is located in the first bore, and inserting a screw into the threaded portion of the second bore and tightening the screw to clamp the outer ring of the at least one rolling-element bearing.

Using the proposed assembly or method it is possible to have a smooth sliding fit for installing the camshaft together with premounted rolling-element bearings so that the installation can be effected in a simple manner. When the rolling-element bearing supporting the camshaft is located in its final installation position, the screw is tightened to fix the outer ring of the bearing in the engine housing, and thus a migration of the ring is substantially prevented.

### BRIEF DESCRIPTION OF THE DRAWINGS

An exemplary embodiment of the invention is depicted in the drawings.

FIG. 1 is a side elevational view of a part of a camshaft.

FIG. 2 is a sectional view of an engine housing of an internal combustion engine illustrating a region in which the bearing of the camshaft is introduced, viewed in the direction of the axis of the camshaft and shown at a first production stage.

FIG. 3 is a sectional view of the region of the engine housing of FIG. 2 at a second production stage.

FIG. 4 is a sectional view of the region of the engine housing of FIG. 2 at a third production stage.

FIG. 5 is a sectional view of the region of the engine housing of FIG. 2 in a fully assembled state.

### DETAILED DESCRIPTION

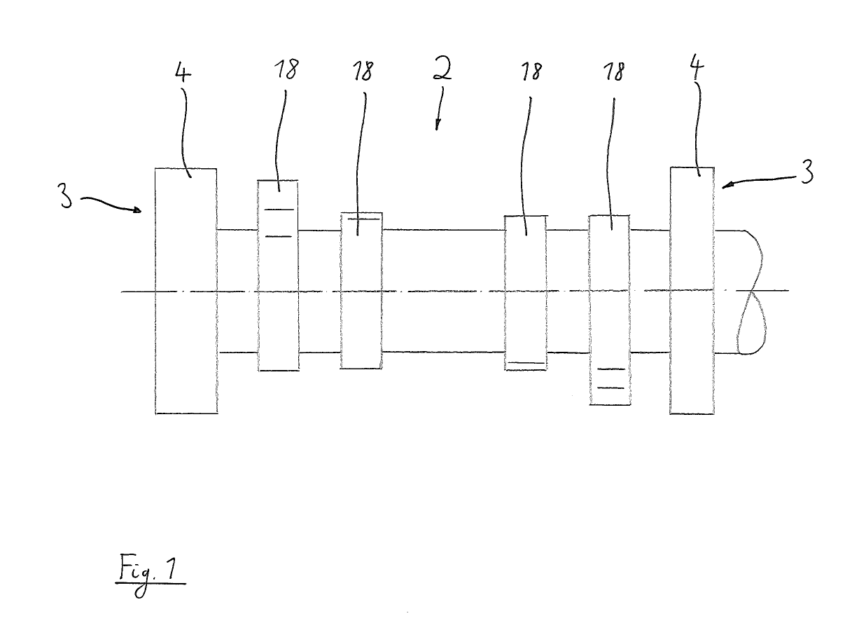

FIG. 1 illustrates a camshaft 2 which is intended to be rotatably mounted in an engine housing shown and described hereinafter. In order to rotatably support the camshaft in the engine housing, at least two rolling-element bearings 3 are premounted on the camshaft 2, and shaft-like sections of the camshaft 2 are supported by these rolling-element bearings 3. The outer rings 4 of the rolling-element bearings 3 are illustrated in FIG. 1. The rolling-element bearings 3 themselves are substantially conventional bearings, preferably needle bearings.

During rotation of the camshaft 2 the cams 18 rotate in a known manner in order to control gas exchange valves of the internal combustion engine.

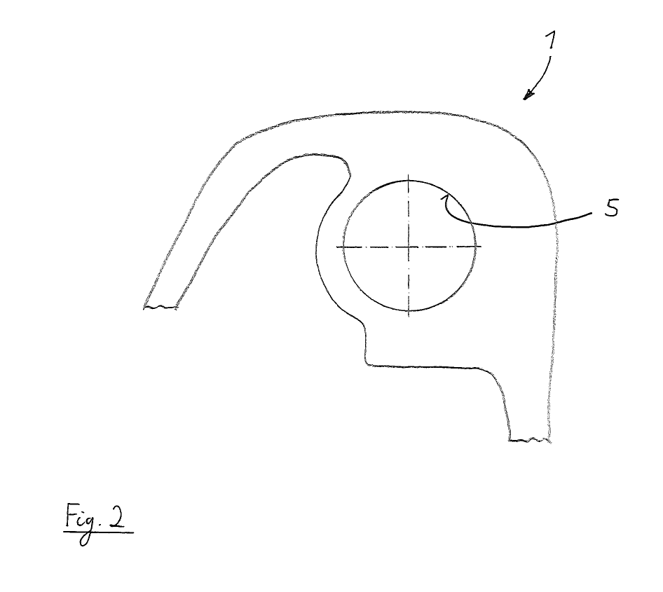

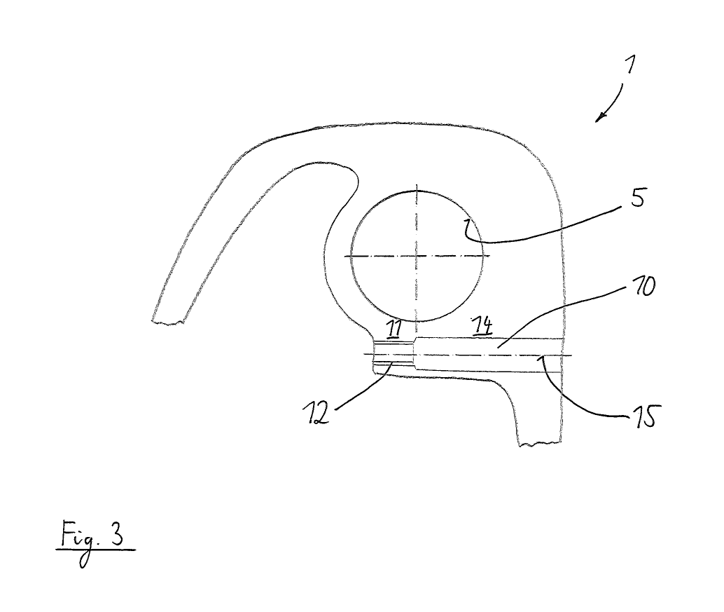

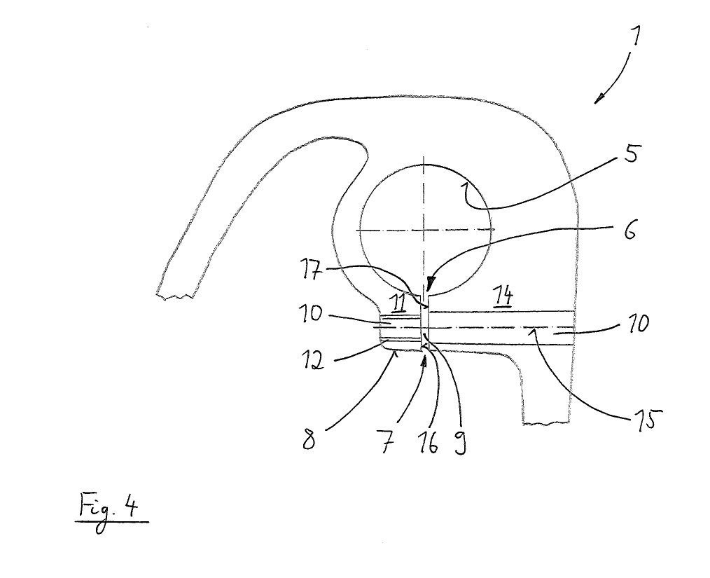

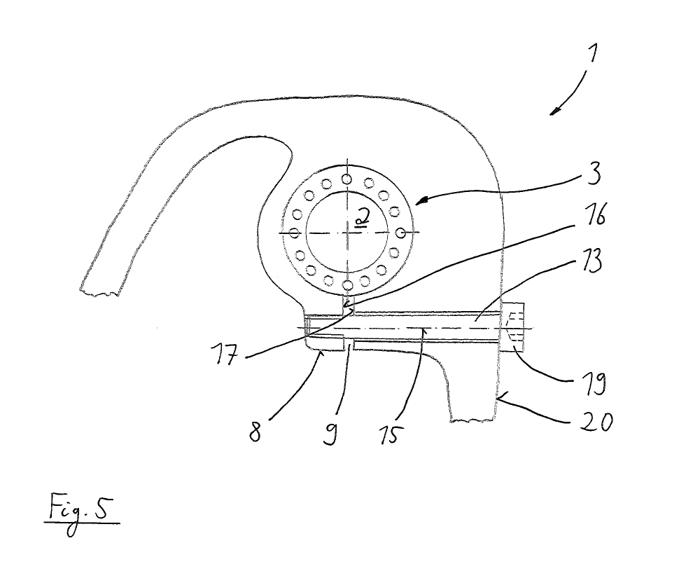

The production of the engine housing 1 and the installation of the camshaft 2 together with the rolling-element bearings 3 in the engine housing 1 will now be explained with reference to FIGS. 2 to 5. Four different production stages are depicted in these figures. In FIG. 2 the engine housing 1 is shown as cast (in its original form) which is then further processed as illustrated in FIGS. 3 and 4. FIG. 5 shows the camshaft 2 completely installed in the engine housing. The section of the engine housing 1 of interest here is illustrated as viewed in the direction of the rotational axis of the camshaft 2. The rotational axis of the camshaft 2 is thus perpendicular to the plane of the drawing.

As shown in FIG. 2, a bore 5 is present in the engine housing 1. The bore can be produced by primary forming (casting), that is by the original process by which the engine housing is formed. The bore may subsequently be brought to a desired nominal diameter by drilling. Once this is accomplished, the bore 5 is brought to a size which later allows the bearing outer ring 4 to be axially pushed into the bore 5. For example, for this purpose the bore 5 is provided with an ISO H7 tolerance.

In the next step—as depicted in FIG. 3—a screw bore 10 is provided below the bore 4. The axis 15 of the screw bore 10 is generally skewed with respect to the rotational axis of the camshaft 2; that is, the axis 15 of the screw bore and that of the camshaft are not parallel and do not intersect. Preferably the axis 15 runs in a direction 90 degrees offset from the rotational axis of the camshaft and is spaced apart therefrom as illustrated in FIG. 3. Part of the screw bore includes a smaller diameter that includes a threaded bore 12.

The threaded bore 12 is located in a first section 11 of the engine housing 1, while the non-threaded section of the screw bore 10 is located in a second section 14 of the engine housing 1. A radius of the bore 5 divides the first section 11 from the second section 14.

A slot-shaped gap 9 is milled from a circumferential point 6 of the bore 5 at least part way through the motor housing 1 up to a point 7 at the surface 8 of the engine housing 1, preferably using a disk milling cutter. The gap 9 separates the two sections 11 and 14 and is delimited by two walls which have opposing boundary surfaces 16 and 17. In the exemplary embodiment, the screw bore 10 passes perpendicularly through the slot-shaped gap 9.

The camshaft 2 can be pushed into the bore 5 together with its premounted rolling-element bearings 3 because the bore 5 is slightly larger than the outer diameters of the outer rings 4 of the rolling element bearings 3. Due to the sliding fit between outer ring 4 and bore 5 this can be effected in a simple manner. When the camshaft 2 and thus also the rolling-element bearings 3 are in the correct axial position, a threaded fastener such as a screw 13 is inserted into the screw bore 10 and tightened in the threaded bore 12.

In this embodiment the screw head 19 is tightened against the outside 20 of the engine housing 1 which pulls the section 11 of the engine housing 1 toward and/or against the section 14 of the engine housing 1 and clamps the outer ring 4 of the rolling-element bearing 3 so it can no longer move. The discontinuity between the section 11 of the engine housing and the section 14 of the engine housing is still referred to as a “gap” even if the opposing boundary surfaces 16, 17 are touching. This arrangement substantially ensures that the outer ring 4 cannot migrate during operation of the internal-combustion engine.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved engine housings having roller-element bearings mounted therein.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Engine housing
2 Camshaft
3 Rolling-element bearing
4 Outer ring
5 Bore
6 Circumferential point
7 Point of the surface
8 Surface of the engine housing
9 Slot-shaped gap
10 Screw bore
11 Section of the engine housing
12 Threaded bore
13 Screw
14 Section of the engine housing
15 Axis of the screw bore
16 Boundary surface
17 Boundary surface
18 Cam
19 Screw head
20 Outside of the engine housing

What is claimed is:

1. An engine housing of an internal combustion engine having at least one bore and a bearing assembly mounted in the at least one bore for rotatably supporting a camshaft such that the camshaft is supported at at least two points axially spaced from one another by first and second rolling-element bearings, each of the first and second rolling-element bearings having an outer ring in the at least one bore,
wherein, a slot-shaped gap extends from a circumferential point of the at least one bore through at least a part of the engine housing up to a surface of the engine housing,
wherein at least one screw bore is disposed in a first portion of the engine housing on a first side of the slot-shaped gap, the screw bore extending to the slot-shaped gap,
wherein a threaded bore is disposed in a second portion of the engine housing on a second side of the slot-shaped gap, and
wherein a threaded fastener extends through the screw bore, across the slot-shaped gap and into the threaded bore and is configured to pull together the first portion of the engine housing and the second portion of the engine housing to clamp the outer ring of at least one of the first and second rolling-element bearings in the at least one bore.

2. The bearing assembly according to claim 1, wherein the slot-shaped gap extends radially relative to the bore.

3. The bearing assembly according to claim 1, wherein an axis of the screw bore is perpendicular to opposing boundary walls of the slot-shaped gap.

4. The bearing assembly according to claim 1, wherein a screw is associated with each of the at least one bore.

5. The bearing assembly according to claim 1, wherein an outer radius of the outer ring of the rolling-element bearing is larger than a largest radial dimension of a cam of the camshaft.

6. The bearing assembly according to claim 1, wherein a head of the threaded fastener abuts on an outer side of the engine housing.

7. The bearing assembly according to claim 1, wherein the rolling-element bearings are needle bearings.

8. The bearing assembly according to claim 1,
wherein the slot-shaped gap extends radially relative to the bore,
wherein an axis of the screw bore is perpendicular to opposing boundary walls of the slot-shaped gap,
wherein an outer radius of the outer ring of the rolling-element bearing is larger than a largest radial extension of a cam of the camshaft, and
wherein a head of the threaded fastener abuts on an outer side of the engine housing,

9. A method for mounting a bearing assembly in at least one bore of an engine housing of an internal combustion engine, the bearing assembly being configured to rotatably support a camshaft at at least two points axially spaced from one another using at least one rolling-element bearing having an outer ring disposed in the at least one bore, the method comprising:
providing an engine housing having a first bore configured to receive the camshaft and the bearing assembly,
enlarging the first bore to a size greater than an outer ring of the at least one rolling-element bearing to enable a sliding fit between the outer ring of the at least one rolling-element bearing and the first bore,
forming a second bore in a part of the engine housing which lies outside the first bore between a circumferential point of the first bore and a point of a surface of the engine housing such that an axis of the second bore is offset from and not parallel to an axis of rotation of the camshaft, the second bore having a threaded portion,
forming a slot-like gap in the engine housing from the circumferential point of the first bore through at least one part of the engine housing up to the point of the surface of the engine housing,
installing the rolling-element bearing assembly supporting the camshaft such that the outer ring of the at least one rolling-element bearing is located in the first bore, and
inserting a threaded fastener into the threaded portion of the second bore and tightening the threaded fastener to clamp the outer ring of the at least one rolling-element bearing.

9. The method according to claim 8, wherein forming a slot-like gap comprises forming a slot-like gap using a disk milling cutter.

10. The method according to claim 8, wherein forming the first bore comprises casting the engine housing with a bore.

11. An engine housing of an internal combustion engine comprising:
a bore;
a rolling element bearing assembly having an outer ring mounted in the bore;
a camshaft rotatably supported by the bearing assembly;
a slot-shaped gap extending from the bore to a surface of the engine housing, the slot-shaped gap having first and second opposing side walls; and
a threaded fastener extending across the slot-shaped gap and configured to draw the first side wall toward the second side wall to clamp the outer ring in the bore.

12. The bearing assembly according to claim 11, wherein the camshaft supports at least one cam and wherein an outer radius of the outer ring is larger than a largest radial extension of the at least one cam.

13. The bearing assembly according to claim 11, wherein the slot-shaped gap extends radially relative to the bore.

14. The bearing assembly according to claim 11, wherein an axis of the threaded fastener is perpendicular to first and second opposing side walls.

15. The bearing assembly according to claim 11, wherein the roller element bearing assembly comprises needle bearings.
